(19) United States
(12) Patent Application Publication
(10) Pub. No.: US 2024/0064050 A1
(43) Pub. Date: Feb. 22, 2024

(54) METHOD AND APPARATUS FOR DETERMINING BANDWIDTH FOR TRANSMISSION OF SRS RESOURCES

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/355,278

(22) Filed: Jul. 19, 2023

Related U.S. Application Data
(60) Provisional application No. 63/394,889, filed on Aug. 3, 2022.
(60) Provisional application No. 63/395,562, filed on Aug. 5, 2022.
(60) Provisional application No. 63/395,727, filed on Aug. 5, 2022.
(60) Provisional application No. 63/396,486, filed on Aug. 9, 2022.

(51) Int. Cl. H04L 27/26; H04L 5/00

(52) U.S. Cl. CPC H04L 27/2613; H04L 5/0048; H04L 5/0012

(57) ABSTRACT

Apparatuses and methods for determining bandwidth for transmission of sounding reference signal (SRS) resources in wireless networks. A method performed includes receiving a configuration about transmission of a SRS resource, the configuration including information about a SRS sequence length of N_{FH}^{BW}>1 and frequency hopping parameters n_{b} and N_{b} , where: N_{FH}^{BW} is a number of an SRS bandwidth and N_{FH}^{BW}>1, n_{b} is a frequency position index, and N_{b} is a value associated with a frequency-hopping pattern. The method further includes determining, based on the SRS sequence length and the frequency hopping parameters, a bandwidth for transmission of the SRS resource over time and transmitting, based on the determined bandwidth, the SRS resource over time.

### CROSS-REFERENCE TO RELATED APPLICATION AND CLAIM OF PRIORITY

This application claims priority under 35 U.S.C. § 119(e) to U.S. Provisional Patent Application No. 63/394,889 filed on Aug. 3, 2022, U.S. Provisional Patent Application No. 63/395,562 filed on Aug. 5, 2022, U.S. Provisional Patent Application No. 63/395,727 filed on Aug. 5, 2022, and U.S. Provisional Patent Application No. 63/396,486 filed on Aug. 9, 2022. The above-identified provisional patent applications are hereby incorporated by reference in their entirety.

### TECHNICAL FIELD

The present disclosure relates generally to wireless communication systems and, more specifically, to electronic devices and methods for determining bandwidth for transmission of sounding reference signal (SRS) resources in wireless networks.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for determining bandwidth for transmission of SRS resources.

In one embodiment, a user equipment (UE) is provided. The UE includes a transceiver configured to receive a configuration about transmission of a sounding reference signal (SRS) resource. The configuration including information about a SRS sequence length of N_{FH}^{BW}>1 and frequency hopping parameters n_{b} and N_{b}, where: N_{FH}^{BW} is a number of an SRS bandwidth and N_{FH}^{BW}>1, n_{b} is a frequency position index, and N_{b} is a value associated with a frequency-hopping pattern. The UE further includes a processor operably coupled to the transceiver. The processor is configured to determine, based on the SRS sequence length and the frequency hopping parameters, a bandwidth for transmission of the SRS resource over time. The transceiver is further configured to transmit, based on the determined bandwidth, the SRS resource over time.

In another embodiment, a base station (BS) is provided. The BS includes a transceiver configured to transmit a configuration about reception of a SRS resource. The configuration includes information about a SRS sequence length of N_{FH}^{BW}>1 and frequency hopping parameters n_{b} and N_{b} , where N_{FH}^{BW} is a number of an SRS bandwidth and N_{FH}^{BW}>1, n_{b} is a frequency position index, and N_{b} is a value associated with a frequency-hopping pattern. The BS further includes a processor operably coupled to the transceiver. The processor is configured to determine, based on the SRS sequence length and the frequency hopping parameters, a bandwidth for reception of the SRS resource over time. The transceiver is further configured to receive, based on the determined bandwidth, the SRS resource over time.

In yet another embodiment, a method performed by a UE is provided. The method includes receiving a configuration about transmission of a SRS resource, the configuration including information about a SRS sequence length of N_{FH}^{BW}>1 and frequency hopping parameters n_{b} and N_{b}, where: N_{FH}^{BW} is a number of an SRS bandwidth and N_{FH}^{BW}>1, n_{b} is a frequency position index, and N_{b} is a value associated with a frequency-hopping pattern. The method further includes determining, based on the SRS sequence length and the frequency hopping parameters, a bandwidth for transmission of the SRS resource over time and transmitting, based on the determined bandwidth, the SRS resource over time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure;

FIG. 5 illustrates an example of different size resource allocation across symbols in frequency hopping according to embodiments of the present disclosure;

FIG. 6 illustrates an example of SRS transmission with pseudo random muting across time symbols according to embodiments of the present disclosure;

FIG. 7 illustrates an example of SRS transmission with pseudo random muting across time slots according to embodiments of the present disclosure; and

FIG. 8 illustrates an example method performed by a UE in a wireless communication system according to embodiments of the present disclosure.

### DETAILED DESCRIPTION

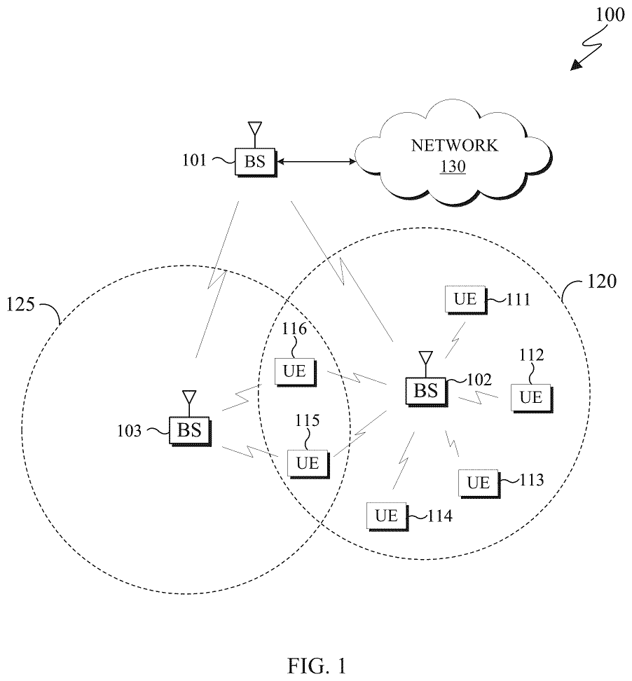

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.1.0, “E-UTRA, Multiplexing and Channel coding” (herein “REF 2”); 3GPP TS 36.213 v17.2.0, “E-UTRA, Physical Layer Procedures” (herein “REF 3”); 3GPP TS 36.321 v17.1.0, “E-UTRA, Medium Access Control (MAC) protocol specification” (herein “REF 4”); 3GPP TS 36.331 v17.1.0, “E-UTRA, Radio Resource Control (RRC) Protocol Specification” (herein “REF 5”); 3GPP TS 38.211 v17.2.0, “NR, Physical channels and modulation” (herein “REF 6”); 3GPP TS 38.212 v17.2.0, “NR, Multiplexing and Channel coding” (herein “REF 7”); 3GPP TS 38.213 v17.2.0, “NR, Physical Layer Procedures for Control” (herein “REF 8”); 3GPP TS 38.214 v17.2.0, “NR, Physical Layer Procedures for Data” (herein “REF 9”); 3GPP TS 38.215 v17.1.0, “NR, Physical Layer Measurements” (herein “REF 10”); 3GPP TS 38.321 v17.1.0, “NR, Medium Access Control (MAC) protocol specification” (herein “REF 11”); 3GPP TS 38.331 v17.1.0, “NR, Radio Resource Control (RRC) Protocol Specification” (herein “REF 12”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

One feature of Rel-18 MIMO items is to introduce coherent joint transmission (C-JT) from multiple TRPs. In time division duplex (TDD), channel acquisition for downlink can be inferred by uplink channel state information through exploiting channel reciprocity. Acquiring uplink channel state information can be done by transmitting SRS from UE. In particular, it becomes to support more UEs in mTRP CJT scenarios compared to sTRP scenarios, which may result in inter-cell interference when receiving SRSs transmitted from many UEs at NW.

In Rel-18 MIMO WID, SRS enhancement has been adopted to provide further flexible configuration to manage inter-TRP interference in TDD C-JT scenarios, as shown in the following description:
4. Study, and if justified, specify enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, considering throughput-overhead trade-off
   SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences
   Note: the maximum number of CSI-RS ports per resource remains the same as in Rel-17, i.e., 32.

The present disclosure considers determining bandwidth for transmission of SRS resources. The present disclosure also considers enhanced SRS frequency hopping to manage inter-TRP interference targeting TDD CJT. Further, the present disclosure considers SRS enhancement to manage inter-TRP interference targeting TDD CJT.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for determining bandwidth for transmission of SRS resources. In certain embodiments, one or more of the BS s 101-103 include circuitry, programing, or a combination thereof for supporting determination of bandwidth for transmission of SRS resources.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

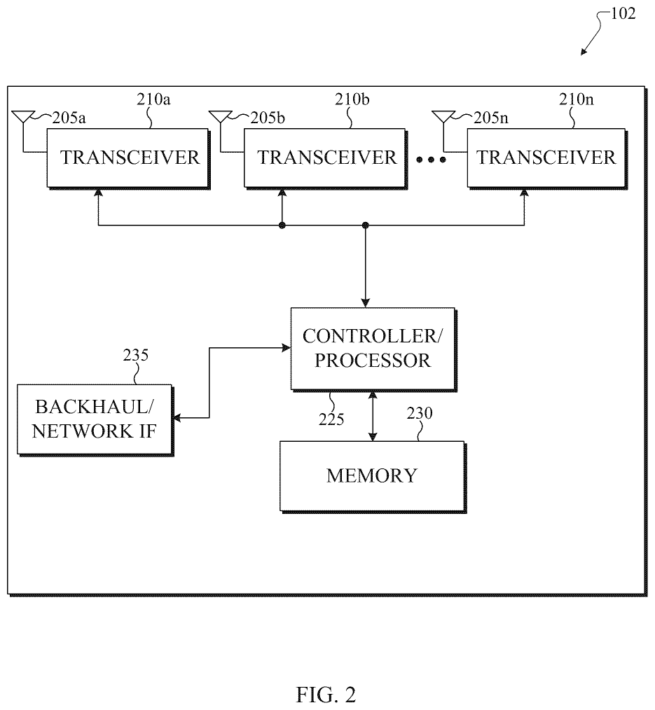

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting determination of bandwidth for transmission of SRS resources. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

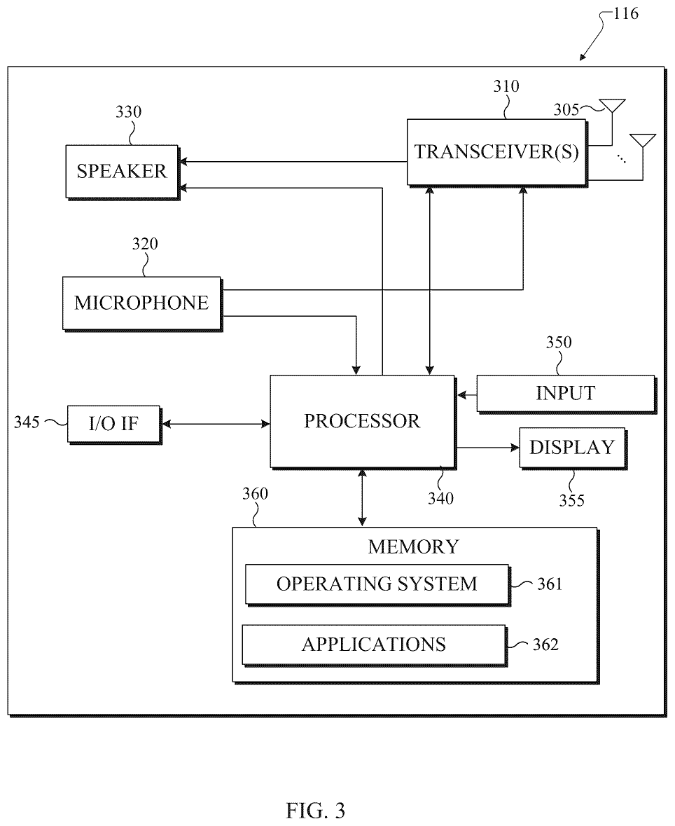

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/0) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for determining bandwidth for transmission of SRS resources. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/0 interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

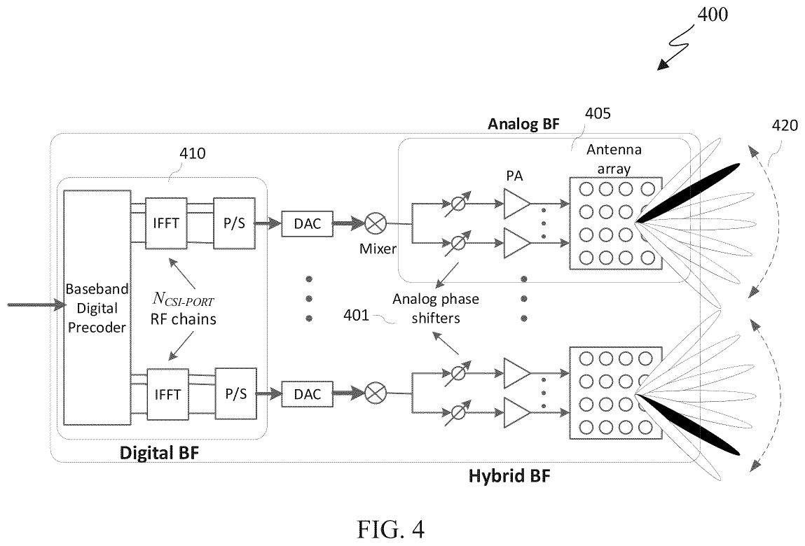

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

Various embodiments of the present disclosure recognize that in the current SRS framework, equal-size BW SRS frequency hopping is allowed, which may limit the ability of allocating an SRS resource. Further, various embodiments of the present disclosure recognize that in the current SRS framework, it is supported that SRS transmission is performed periodically, semi-persistently, or aperiodically. For the case of periodical or semi-persistent SRS transmission, SRS transmissions may be redundant for a certain set of times and could affect interference to other uplink signals (e.g., SRS interference for TDD CJT scenario). Also, changing RRC parameters to differentiate periodicity of SRS transmission may induce huge overhead.

Various embodiments of the present disclosure recognize that the overall interference in the system may be reduced as some UEs do not transmit SRS on some occasions. Various embodiments of the present disclosure recognize that for a given SRS resource of a given UE, in different instances of transmission (in different slots / symbols), different sets of UEs create interference. The present disclosure proposes mechanisms to avoid persistent interference.

Accordingly, various embodiments of the present disclosure provide mechanisms for enabling an unequal-size BW SRS frequency hopping method, thereby reducing or avoiding persistent interference. Further, various embodiments of the present disclosure provide mechanisms for varying the length of SRS BW (M_{sc,b}^{SRS}) across a time index in a frequency hopping SRS transmission and to adjust frequency-domain position offset (n_{offset}^{FH}). Further, various embodiments of the present disclosure provide mechanisms for enabling SRS transmission with pseudo-random muting to potentially reduce SRS interference in a wireless system.

In TDD, SRS transmissions from UEs are a main source for CSI acquisition at the gNB as to both of UL and DL channels. SRS transmissions, however, can be more congested in a multi-TRP (mTRP) scenario wherein a gNB controlling mTRP capable of CJT can support more UEs (associated with a given cell ID) and need more frequent CSI acquisition. This can result in increasing the possibility of scheduling SRS resources for multiple UEs that are overlapping in given time-and-frequency resources. Therefore, potential interference across SRS transmissions from multiple UEs can be severe in congested mTRP scenarios, and thus an SRS enhancement could be needed to manage inter-TRP/cross-SRS interference targeting TDD CJT.

Under the three constraints described in Rel-18 WID, the following two directions can be considered to randomize or manage inter-TRP cross-SRS interference:
Enhanced frequency hopping pattern
Enhanced code-domain (e.g., cyclic shift, root sequence, comb offset) hopping
SRS transmission muting.

In Rel-17 SRS enhancement, the supported number of symbol repetitions has been increased up to 14 for SRS coverage enhancement. This could be useful in TDD CJT scenarios wherein cell-edge UEs that usually need a larger number of symbol repetitions are targeted as CJT candidates. On the other hand, inter-SRS interference could be worse across such scheduled UEs due to that situations under limited time/frequency resources can further frequently happen. To reduce interference in such scenarios, code-domain hopping (e.g., cyclic shift, and sequence group/number) across time symbols/slots can be considered for interference randomization across scheduled UEs. Code-domain hopping across symbols in frequency hopping SRS transmission can also be considered. In addition to code-domain hopping, frequency-domain hopping can be another approach to reduce inter-SRS interference. The present disclosure considers and proposes enhanced SRS frequency hopping patterns.

Additionally, SRS muting can be considered in a pseudo-random manner. In this case, “hopping” is in the domain of whether a given SRS symbols / SRS resource for a given UE at a given instant in time is transmitted or not. The benefit can be two-fold: First, the overall interference in the system is reduced as some UEs do not transmit SRS on some occasions. Second, for a given SRS resource of a given UE, in different instances of transmission (in different slots/symbols), different sets of UEs create interference to avoid persistent interference.

An SRS resource is configured by the SRS-Resource IE or the SRS-PosResource IE and includes:

$${\{ {p}_{i} \}}_{i = 0}^{{N}_{ap}^{SRS} - 1} ,$$

Nₐₚ^{SRS}∈{1, 2, 4} antenna ports where the number of antenna ports is given by the higher layer parameter nrofSRS-Ports if configured, otherwise Nₐₚ^{SRS}=1, and pᵢ=1000+i when the SRS resource is in a SRS resource set with higher-layer parameter usage in SRS-ResourceSet not set to ‘nonCodebook’, or determined according to [6, TS 38.214] when the SRS resource is in a SRS resource set with higher-layer parameter usage in SRS-ResourceSet set to ‘nonCodebook’
N_{symb}^{SRS}∈{1, 2, 4, 8, 10, 12, 14} consecutive OFDM symbols given by the field nrofSymbols contained in the higher layer parameter resourceMapping
l₀, the starting position in the time domain given by l₀=N_{symb}^{slot}−1−l_{offset} where the offset l_{offset}∈{0, 1, . . . , 13} counts symbols backwards from the end of the slot and is given by the field startPosition contained in the higher layer parameter resourceMapping and l_{offset}≥N_{symb}^{SRS}−1
k₀, the frequency-domain starting position of the sounding reference signal

The sounding reference signal sequence for an SRS resource shall be generated according to

r^{(p}^{ᵢ}⁾(n,l′)=r_{u,v}^{(a}^{ᵢ}^{,δ)}(n)

0≤n≤M_{sc,b}^{SRS}−1

l′∈{0,1, . . . ,N_{symb}^{SRS}−1}

where M_{sc,b}^{SRS} is given by clause 6.4.1.4.3 of [6], r_{u,v}^{(a,δ)}(n) is given by clause 5.2.2 of [6] with δ=log₂(K_{TC}) and the transmission comb number K_{TC}∈{2 ,4, 8} is contained in the higher-layer parameter transmissionComb. The cyclic shift aᵢ for antenna port pᵢ is given as

$${α}_{i} = 2 π \frac{{n}_{SRS}^{cs , i}}{{n}_{SRS}^{cs , max}} {n}_{SRS}^{cs , i} = \{ \begin{matrix}( {n}_{SRS}^{cs} + \frac{{n}_{SRS}^{cs , max} ⌊ ( {p}_{i} - 1 \; 000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix} ,$$

$${n}_{SRS}^{cs , i} = \{ \begin{matrix}( {n}_{SRS}^{cs} + \frac{{n}_{SRS}^{cs , max} ⌊ ( {p}_{i} - 1 \; 000 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix}$$

where n_{SRS}^{cs}∈{0, 1, . . . , n_{SRS}^{cs,max}−1} is contained in the higher layer parameter transmissionComb. The maximum number of cyclic shifts n_{SRS}^{cs,max} are given by Table 6.4.1.4.2-1 of [6].

TABLE 6.4.1.4.2-1
Maximum number of cyclic shifts n_{SRS}^{cs,max}
as a function of K_{TC}.

| KTC | n_{SRS}^{cs,max} |
|---|---|
| 2 | 8 |
| 4 | 12 |
| 8 | 6 |

When SRS is transmitted on a given SRS resource, the sequence r^{(p}^{ᵢ}⁾(n, l′) for each OFDM symbol l′ and for each of the antenna ports of the SRS resource shall be multiplied with the amplitude scaling factor β_{SRS} in order to conform to the transmit power specified in [8] and mapped in sequence starting with r^{(p}^{ᵢ}⁾(0, l′) to resource elements (k, l) in a slot for each of the antenna ports pᵢ according to:

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix} .$$

The length of the sounding reference signal sequence is given by:

M_{sc,b}^{SRS}=m_{SRS,b}N_{sc}^{RB}/(K_{TC}P_{F})

where m_{SRS,b} is given by a selected row of Table 6.4.1.4.3-1 of [6] with b=B_{SRS} where B_{SRS}∈{0, 1, 2, 3} is given by the field b-SRS contained in the higher-layer parameter freqHopping if configured, otherwise B_{SRS}=0. The row of the table is selected according to the index C_{SRS}∈{0, 1, . . . , 63} given by the field c-SRS contained in the higher-layer parameter freqHopping. The quantity P_{F}∈{2, 4} is given by the higher-layer parameter FreqScalingFactor if configured, otherwise P_{F}=1. When FreqScalingFactor is configured, the UE expects the length of the SRS sequence to be a multiple of 6.

The frequency-domain starting position k₀^{(p}^{ᵢ}⁾ is defined by:

$${k}_{0}^{( {p}_{i} )} = {\overline{k}}_{0}^{( {p}_{i} )} + {n}_{offset}^{FH} + {n}_{offset}^{RPFS}$$

$$\text{where:}$$

$${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}$$

$${k}_{TC}^{( {p}_{i} )} = \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} = 6 \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs} ∈ \{ {n}_{SRS}^{cs , max} / 2 , … , {n}_{SRS}^{cs , max} - 1 \} \\ {\overline{k}}_{TC} & otherwise\end{matrix}$$

$${n}_{offset}^{FH} = {\sum }_{b = 0}^{{B}_{SRS}} {m}_{SRS , b} {N}_{sc}^{RB} {n}_{b}$$

$${n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

and
k_{F}∈{0, 1, . . . , P_{F}−1} is given by the higher-layer parameter StartRBIndex if configured, otherwise k_{F}=0;
kₕₒₚ is given by Table 6.4.1.4.3-3 of [6] with

$${\overline{k}}_{hop} = ⌊ \frac{{n}_{SRS}}{{\prod }_{{b}^{′} = {b}_{hop}}^{{B}_{SRS}} {N}_{{b}^{′}}} ⌋ mod {P}_{F}$$

$${N}_{{b}_{hop}} = 1$$

if the higher-layer parameter EnableStartRBHopping is configured, otherwise kₕₒₚ=0.

If N_{BWP}^{start}≤n_{shift} the reference point for k₀^{(p}^{ᵢ}⁾=0 is subcarrier 0 in common resource block 0, otherwise the reference point is the lowest subcarrier of the BWP. If the SRS is configured by the IE SRS-PosResource, the quantity k_{offset}^{l′} is given by Table 6.4.1.4.3-2 of [6], otherwise k_{offset}^{l′}=0.

The frequency domain shift value n_{shift} adjusts the SRS allocation with respect to the reference point grid and is contained in the higher-layer parameterfreqDomainShift in the SRS-Resource IE or the SRS-PosResource IE. The transmission comb offset k̅_{TC}∈{0, 1, . . . , K_{TC}−1} is contained in the higher-layer parameter transmission Comb in the SRS-Resource IE or the SRS-PosResource IE and n_{b} is a frequency position index.

Frequency hopping of the sounding reference signal is configured by the parameter bₕₒₚ∈{0, 1, 2, 3}, given by the field b-hop contained in the higher-layer parameter freqHopping if configured, otherwise bₕₒₚ=0.

If bₕₒₚ≥B_{SRS}, frequency hopping is disabled and the frequency position index n_{b} remains constant (unless re-configured) and is defined by

n_{b}=└4n_{RRC}/m_{SRS,b}┘mod N_{b}

for all N_{symb}^{SRS} OFDM symbols of the SRS resource. The quantity n_{RRC} is given by the higher-layer parameter freqDomainPosition if configured, otherwise n_{RRC}=0, and the values of m_{SRS,b} and N_{b} for b=B_{SRS} are given by the selected row of Table 6.4.1.4.3-1 of [6] corresponding to the configured value of C_{SRS}.

If bₕₒₚ<B_{SRS}, frequency hopping is enabled and the frequency position indices n_{b} are defined by

$${n}_{b} = \{ \begin{matrix}⌊ 4 {n}_{RRC} / {m}_{SRS , b} ⌋ mod {N}_{b} & b \leq {b}_{hop} \\ ( {F}_{b} ( {n}_{SRS} ) + ⌊ 4 {n}_{RRC} / {m}_{SRS , b} ⌋ ) mod {N}_{b} & otherwise\end{matrix}$$

where N_{b} is given by Table 6.4.1.4.3-1,

$${F}_{b} ( {n}_{SRS} ) = \{ \begin{matrix}( {N}_{b} / 2 ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋ & if {N}_{b} even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{b} odd\end{matrix}$$

and where

$${N}_{{b}_{hop}} = 1$$

regardless of the value of N_{b}. The quantity n_{SRS} counts the number of SRS transmissions. For the case of an SRS resource configured as aperiodic by the higher-layer parameter resource Type, it is given by n_{SRS}=└l′/R┘ within the slot in which the N_{symb}^{SRS} symbol SRS resource is transmitted. The quantity R≤N_{symb}^{SRS} is the repetition factor given by the field repetitionFactor if configured, otherwise R=N_{symb}^{SRS}.

For the case of an SRS resource configured as periodic or semi-persistent by the

higher-layer parameter resourceType, the SRS counter is given by

$${n}_{SRS} = ( \frac{{N}_{slot}^{frame , μ} {n}_{f} + {n}_{s , f}^{μ} - {T}_{offset}}{{T}_{SRS}} ) \cdot ( \frac{{N}_{symb}^{SRS}}{R} ) + ⌊ \frac{{l}^{′}}{R} ⌋$$

for slots that satisfy (Nₛₗₒₜ^{frame,μ}n_{ƒ}+n_{s,f}^{μ}−T_{offset})mod T_{SRS}=0. The periodicity T_{SRS} in slots and slot offset T_{offset} are given in clause 6.4.1.4.4 of [6].

Due to asymmetric distances from TRPs for a given UE, it could be beneficial to allow more flexible SRS resource allocation, for example, that enables different RB size allocation across symbols in frequency hopping SRS transmission. By assigning uneven (unequal) size of RBs across symbols, controlling stronger/weaker power allocations across symbols can be feasible to randomize/manage interference with consideration for distant/close TRPs in UL CSI acquisition. Notice that when SRS transmissions for multiple UEs in given time-and-frequency resources need to be scheduled, power-domain difference across the UEs and symbols can also be exploited through enhanced frequency hopping patterns, e.g., gNB can schedule SRS resources for multiple UEs to be overlapping on time-and-frequency domains but differentiating in power domain on purpose, considering advanced receiver methods (e.g., successive interference cancellation, SIC, advanced inter-/extrapolation methods) are utilized at the gNB.

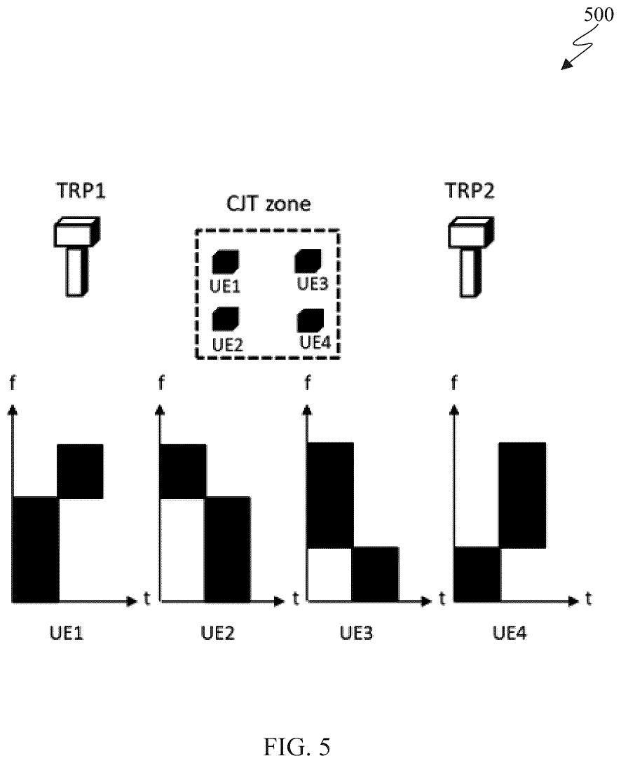

FIG. 5 illustrates an example of different size resource allocation across symbols in frequency hopping 500 according to embodiments of the present disclosure. The embodiment of the example of different size resource allocation across symbols in frequency hopping 500 illustrated in FIG. 5 is for illustration only. FIG. 5 does not limit the scope of this disclosure to any particular implementation of the example of different size resource allocation across symbols in frequency hopping 500.

As shown in FIG. 5, the gNB allocates different-size resource allocation for each UE with consideration for distant/close TRPs. Here, the gNB assigns orthogonal resources for UEs experiencing similar signal powers from TRPs (e.g., UE1/UE2 pair, UE3/UE4 pair) with allowing partially overlapping resources for UEs experiencing different signal powers from TRPs (e.g., UE1/UE3, UE2/UE4). The interference for the partially overlapping resources across the UEs can be handled by advanced receiver techniques at the gNB by exploiting signal power differences, which NW can consider before scheduling SRS resources for the UEs.

In one embodiment, an SRS resource is generated based on an enhanced frequency-hopping method, where the enhanced frequency-hopping method allows unequal-size SRS bandwidth (BW) allocation across time symbols/slots (or subframe/frame). A UE can be configured with higher-layer parameter for unequal-size SRS bandwidth allocation across time symbols/slots.

In one embodiment, the length of the sounding reference signal (SRS) sequence is given by M_{sc,b}^{SRS}=m_{SRS,b}N_{sc}^{RB}·X/(K_{TC}P_{F}), where X is a quantity that can vary the length of SRS sequence across time index.

In one example, X is a function of n_{b} and N_{b}, for example,

$$X = f ( {n}_{b} , {N}_{b} ) = ℊ ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$

where g(x) is a function of x∈{0, 1, . . . , N_{BW}^{FH}−1}, and N_{BW}^{FH} is a number of (possible) SRS BWs in an SRS frequency-hopping configuration. In one example, N_{BW}^{FH} is fixed, e.g., N_{BW}^{FH}=2, or can be configured via higher-layer parameter, MAC-CE, or DCI.

Note that (Σ_{b=0}^{B}^{_{SRS}}n_{b}·Π_{b′=b+1}^{B}^{_{SRS}}N_{b′}) is to compute a decimal number corresponding to n₀n₁ . . . n_{B}_{_{SRS}}, where n₀ is the most significant digit and n_{B}_{_{SRS}} is the least significant digit when n_{b} is N_{b}-nary digit for b=0, 1, . . . , n_{B}_{_{SRS}}.

In one example, N_{BW}^{FH}∈{2, 3, 4, 5}. In another example, N_{BW}^{FH}∈{2, 4, 6, 8}. In another example, N_{BW}^{FH}∈{2, 4, 8}. In another example, N_{BW}^{FH}∈{2, 4}. another example, N_{BW}^{FH}∈{2, 3}.

In one example, g(x) is according to at least one of the following examples.
In one example, g(x)=½ or 3/2, where x∈{0, 1}. For example, g(0)=1/2 and g(1)= 3/2. In another example, g(0)= 3/2 and g(1)=½.
In one example, g(x)=½, 1, or 3/2, where x∈{0, 1, 2}. For example, g(0)=½, g(1)=1 and g(2)= 3/2. In another example, g(0)= 3/2, g(1)=1 and g(2)=½.
In one example, g(x)=¼, ½, 3/2, or 7/4, where x∈{0, 1, 2, 3}. For example, g(0)=¼, g(1)=½, g(2)= 3/2, and g(3)= 7/4. In another example, g(0)= 7/4, g(1)= 3/2, g(2)=½, and g(3)=¼.
In one example g(x)=¼, ¾, 5/4, or 7/4, where x∈{0, 1, 2, 3}. For example, g(0)=¼, g(1)=¾, g(2)= 5/4, and g(3)= 7/4. In another example, g(0)= 7/4, g(1)= 5/4, g(2)=¾, and g(3)=¼.
In one example, g(x)=¼, ½, 1, 3/2, or 7/4, where x∈{0, 1, 2, 3, 4}. For example, g(0)=¼, g(1)=½, g(2)=1, g(3)= 3/2, and g(4)= 7/4. In another example, g(0)= 7/4, g(1)= 3/2, g(2)=1, g(3)=½, and g(4)=¼.
In one example, similar to the above examples, we can extend those to the case of N_{BW}^{FH}=5, 6, . . . and so on.
In one example,

$$ℊ ( x ) = \frac{1}{k} or \frac{2 k - 1}{k} ,$$

where x∈{0, 1}.
   In one example, k is fixed, e.g., k=2.
   In one example, k∈ [symbol] and can be configured via RRC, MAC-CE, or DCI. In one example, [symbol] ={2, 4}. In another example, [symbol] ={2, 4, 6, 8}.
In one example,

$$ℊ ( x ) = \frac{1}{k} , 1 or \frac{2 k - 1}{k} ,$$

where x∈{0, 1, 2}. Similar to the above examples, k can be fixed or configured via RRC, MAC-CE, or DCI.
In one example,

$$ℊ ( x ) = \frac{1}{{k}_{1}} , \frac{1}{{k}_{2}} , \frac{2 {k}_{2} - 1}{{k}_{2}} , or \frac{2 {k}_{1} - 1}{{k}_{1}} ,$$

where x∈{0, 1, 2, 3}.
   In one example, k₁ and k₂ are fixed, e.g., (k₁, k₂)=(4, 2).
   In one example, k₁∈ [symbol] ₁ and k₂∈ [symbol] ₂ and each of k₁ and k₂ can be configured via RRC, MAC-CE or DCI. In one example, [symbol] ₁={6, 8} and [symbol] ₂={2, 4}.
   In one example, k₁ is determined by k₂, e.g., k₁=2k₂. For example, k₂∈ [symbol] and only k₂ can be configured via RRC, MAC-CE or DCI. In one example, [symbol] ₂={2, 4}, and so on.
In one example,

$$ℊ ( x ) = \frac{1}{{k}_{1}} , \frac{1}{{k}_{2}} , 1 , \frac{2 {k}_{2} - 1}{{k}_{2}} , or \frac{2 {k}_{1} - 1}{{k}_{1}} ,$$

where x∈{0, 1, 2, 3, 4}. Similar to the above examples, k₁ and k₂ can be fixed, determined in a pre-rule, or configured via RRC, MAC-CE, or DCI.
In one example, similar to the above examples, we can extend those to the case of N_{BW}^{FH}=5, 6, . . . and so on.
In one example,

$$ℊ ( x ) = \frac{n}{k} or \frac{2 k - n}{k} ,$$

where x∈{0, 1}.
   In one example, k is fixed, e.g., k=2.
   In one example, k∈ [symbol] and can be configured via RRC, MAC-CE, or DCI. In one example, [symbol] ={2, 4}. In another example, [symbol] ={2, 4, 6, 8}.
   In one example, n is fixed, or determined in a rule, or configured via RRC, MAC-CE, or DCI.
In one example,

$$ℊ ( x ) = \frac{n}{k} , 1 or \frac{2 k - n}{k} ,$$

where x∈{0, 1,2}. Similar to the above examples, k, n can be fixed, determined in a rule, or configured via RRC, MAC-CE, or DCI.
In one example,

$$ℊ ( x ) = \frac{{n}_{1}}{{k}_{1}} , \frac{{n}_{2}}{{k}_{2}} , \frac{2 {k}_{2} - {n}_{2}}{{k}_{2}} , or \frac{2 {k}_{1} - {n}_{1}}{{k}_{1}} ,$$

where x∈{0, 1, 2, 3}.
   In one example, k₁ and k₂ are fixed, e.g., (k₁, k₂)=(4, 2).
   In one example, k₁∈ [symbol] ₁ and k₂∈ [symbol] ₂ and each of k₁ and k₂ can be configured via RRC, MAC-CE or DCI. In one example, [symbol] ₁={6, 8} and [symbol] ₂={2, 4}.
   In one example, k₁ is determined by k₂, e.g., k₁=2k₂. For example, k₂∈ [symbol] ₂ and only k₂ can be configured via RRC, MAC-CE or DCI. In one example, [symbol] ₂={2, 4}, and so on.
   In one example, n₁ and n₂ are fixed, or determined in a rule or configured viar RRC, MAC-CE, or DCI.
In one example,

$$ℊ ( x ) = \frac{{n}_{1}}{{k}_{1}} , \frac{{n}_{2}}{{k}_{2}} , 1 , \frac{2 {k}_{2} - {n}_{2}}{{k}_{2}} , or \frac{2 {k}_{1} - {n}_{1}}{{k}_{1}} ,$$

where x∈{0, 1, 2, 3, 4}. Similar to the above examples, k₁, k₂, n₁, and n₂ can be fixed, determined in a pre-rule, or configured via RRC, MAC-CE, or DCI.
In one example, similar to the above examples, we can extend those to the case of N_{BW}^{FH}=5, 6, . . . and so on.

In one example, the outputs of g(x) are determined according to a table for g(x). For example, the table includes a configuration parameter, e.g., g_{config}, which indicates N_{BW}^{FH}, and outputs of g(x). For example, the table can include at least one of the entries in the following table:

TABLE 1
g(x) and N^{FH}_{BW} configuration

| g_{config} | N^{FH}_{BW} | g(0) | g(1) | g(2) | g(3) | . . . |
|---|---|---|---|---|---|---|
| 0 | 2 | ½ | 3/2 | — | — | |
| 1 | 2 | 1/3 | 5/3 | — | — | |
| 2 | 2 | ¼ | 7/4 | — | — | |
| 3 | 2 | 1/5 | 9/5 | — | — | |
| 4 | 2 | 1/6 | 11/6 | — | — | |
| 5 | 2 | 1/8 | 15/8 | — | — | |
| 6 | 2 | ¾ | 5/4 | — | — | |
| 7 | 2 | 3/8 | 13/8 | — | — | |
| 8 | 2 | 5/8 | 11/8 | — | — | |
| 9 | 2 | 7/8 | 9/8 | — | — | |
| 10 | 3 | ½ | 1 | 3/2 | — | |
| 11 | 3 | ¼ | 1 | 7/4 | — | |
| 12 | 3 | 1/8 | 1 | 15/8 | — | |
| 13 | 3 | ¾ | 1 | 5/4 | — | |
| 14 | 3 | 3/8 | 1 | 13/8 | — | |
| 15 | 3 | 5/8 | 1 | 11/8 | — | |
| 16 | 3 | 7/8 | 1 | 9/8 | — | |
| 17 | 4 | 1/4 | 1/2 | 3/2 | 7/4 | |
| 18 | 4 | 1/8 | 1/2 | 3/2 | 15/8 | |
| 19 | 4 | 1/8 | 1/4 | 7/4 | 15/8 | |
| 20 | 4 | 1/4 | 3/4 | 5/4 | 7/4 | |
| 21 | 4 | 1/8 | 3/8 | 13/8 | 15/8 | |
| 22 | 4 | 1/8 | 5/8 | 11/8 | 15/8 | |
| 23 | 4 | 1/8 | 7/8 | 9/8 | 15/8 | |
| 24 | 4 | 3/8 | 5/8 | 11/8 | 13/8 | |
| | 4 | 3/8 | 7/8 | 9/8 | 13/8 | |
| 26 | 4 | 5/8 | 7/8 | 9/8 | 11/8 | |
| . . . | . . . | . . . | . . . | . . . | . . . | |

In one example, the table for g(x) is a table including any permutation of outputs of g(x) for any row in Table 1.

In one example, the table for g(x) is a table including any possible outputs of g(x) that can be described herein.

In one example, the outputs of g(x) are determined according to a table for g(x). For example, the table includes a configuration parameter, e.g., g_{config}, which indicates outputs of g(x) when N_{BW}^{FH} is given (e.g., by another parameter). For example, the table for a given N_{BW}^{FH} can include at least one of the entries in the following table:

TABLE 2
g(x) configuration for and N_{BW}^{FH} = 2

| g_{config} | g(0) | g(1) |
|---|---|---|
| 0 | ½ | 3/2 |
| 1 | 1/3 | 5/3 |
| 2 | ¼ | 7/4 |
| 3 | 1/5 | 9/5 |
| 4 | 1/6 | 11/6 |
| 5 | 1/8 | 15/8 |
| 6 | ¾ | 5/4 |
| 7 | 3/8 | 13/8 |
| 8 | 5/8 | 11/8 |
| 9 | 7/8 | 9/8 |
| . . . | . . . | . . . |

TABLE 3
g(x) configuration for and N_{BW}^{FH} = 3

| g_{config} | g(0) | g(1) | g(2) |
|---|---|---|---|
| 0 | ½ | 1 | 3/2 |
| 1 | ¼ | 1 | 7/4 |
| 2 | 1/8 | 1 | 15/8 |
| 3 | ¾ | 1 | 5/4 |
| 4 | 3/8 | 1 | 13/8 |
| 5 | 5/8 | 1 | 11/8 |
| 6 | 7/8 | 1 | 9/8 |
| . . . | . . . | . . . | . . . |

TABLE 4
g(x) configuration for and N_{BW}^{FH} = 4

| g_{config} | g(0) | g(1) | g(2) | g(3) |
|---|---|---|---|---|
| 0 | 1/4 | 1/2 | 3/2 | 7/4 |
| 1 | 1/8 | 1/2 | 3/2 | 15/8 |
| 2 | 1/8 | 1/4 | 7/4 | 15/8 |
| 3 | 1/4 | 3/4 | 5/4 | 7/4 |
| 4 | 1/8 | 3/8 | 13/8 | 15/8 |
| 5 | 1/8 | 5/8 | 11/8 | 15/8 |
| 6 | 1/8 | 7/8 | 9/8 | 15/8 |
| 7 | 3/8 | 5/8 | 11/8 | 13/8 |
| 8 | 3/8 | 7/8 | 9/8 | 13/8 |
| 9 | 5/8 | 7/8 | 9/8 | 11/8 |
| . . . | . . . | . . . | . . . | . . . |

In one example, the table for g(x) for a given N_{BW}^{FH} is a table including any permutation of outputs of g(x) for any row in Table 2, 3, or 4.

In one example, the table for g(x) for a given N_{BW}^{FH} is a table including any possible outputs of g(x) that can be described herein.

In one example, an offset value a_{offset} can be considered for computing X. For example, the offset value a_{offset} is added before a modulo operation of N_{BW}^{FH}, which can shift SRS BW length pattern, which is defined by g(x), by a_{offset}. One example can be as follows:

$$X = f ( {n}_{b} , {N}_{b} ) = ℊ ( ( {a}_{offset} + {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) .$$

In one example, a_{offset}∈{0, 1, . . . N_{BW}^{FH}−1} can be configured by RRC, MAC-CE, or DCI.

In one example, a_{offset} can depend on time index, for example, time slot/subframe/frame. In one example, a_{offset}∈{0, 1, . . . , N_{BW}^{FH}−1} is based on a pseudo-random function.

In one example, a pseudo-random function h(·) can be considered for computing X. For example, the pseudo-random function h(·) is added before a modulo operation of N_{BW}^{FH}, which can pseudo-randomly change the order of SRS BW length pattern that is defined by g(x). One example can be as follows:

$$X = f ( {n}_{b} , {N}_{b} ) = ℊ ( h ( ( {\sum }_{b = 0}^{{B}_{SRS}} {n}_{b} \cdot {\prod }_{{b}^{′} = b + 1}^{{B}_{SRS}} {N}_{{b}^{′}} ) ) mod {N}_{BW}^{FH} ) .$$

In one example, a pseudo-random function h(·) is a function using the pseudo random sequence c(·) defined by clause 5.2.1 of [6].

In one embodiment, the length of the sounding reference signal (SRS) sequence is given by

M_{sc,b}^{SRS}=m_{SRS,b}N_{sc}^{RB}/(K_{TC}P_{F})+X′,

where X′ is a quantity that can vary the length of SRS sequence across time index.

Similar to embodiments herein, X′ can be computed as a function of n_{b} and N_{b′}. In this embodiment, each case of X′ corresponding to each case for computing X in embodiments herein is included.

In one example, X′ is a function of n_{b} and N_{b}, for example,

$${X}^{′} = m ( ( {\sum }_{b = 0}^{{B}_{SRS}} {n}_{b} \cdot {\prod }_{{b}^{′} = b + 1}^{{B}_{SRS}} {N}_{{b}^{′}} ) ) mod {N}_{BW}^{FH} ) ,$$

where m(x) is a function of x∈{0, 1, . . . , N_{BW}^{FH}−1}, and N_{BW}^{FH} is a number of (possible) SRS BWs in an SRS frequency-hopping configuration. In one example, N_{BW}^{FH} is fixed, e.g., N_{BW}^{FH}=2, or can be configured via higher-layer parameter, MAC-CE, or DCI.

In one example, m(x)=(m_{SRS,b}N_{sc}^{RB}/(K_{TC}P_{F}))·m′(x), where m′(x) is according to at least one of the following examples.
In one example, m′(x)=½ or −½, where x∈{0, 1}. For example, m′(0)=½ and m′(1)=−½. In another example, m′(0)=−½ and m′(1)=½.
In one example, m′(x)=½, 0, or −½, where x∈{0, 1, 2}. For example, m′(0)=½, m′(1)=0 and m′(2)=−½. In another example, m′(0)=−½, m′(1)=0 and m′(2)=½.
In one example, m′(x)=−¾, −½, ½, or ¾, where x∈{0, 1, 2, 3}. For example, m′(0)=−¾, m′(1)=−½, m′(2)=½, and m′(3)=¾. In another example, m′(0)=¾, m′(1)=½, m′(2)=−½, and m′(3)=−¾.
In one example m′(x)=−¾, −¼, ¼, or ¾, where x∈{0, 1, 2, 3}. For example, m′(0)=−¾, m′(1)=−¼, m′(2)=¼, and m′(3)=¾. In another example, m′(0)=¾, m′(1)=¼, m′(2)=−¼, and m′(3)=−¾.
In one example, m′(x)=−¾, −½, 0, ½, or ¾, where x∈{0, 1, 2, 3, 4}. For example, m′(0)=−¾, m′(1)=−½, m′(2)=0, m′(3)=½, and m′(4)=¾. In another example, m′(0)=¾, m′(1)=½, m′(2)=0, m′(3)=−½, and m′(4)=−¾.
In one example, similar to the above examples, we can extend those to the case of N_{BW}^{FH}=5, 6, . . . and so on.
In one example,

$${m}^{′} ( x ) = \frac{1}{k} - 1 or 1 - \frac{1}{k} ,$$

where x∈{0, 1}.
   In one example, k is fixed, e.g., k=2.
   In one example, k∈ [symbol] and can be configured via RRC, MAC-CE, or DCI. In one example, [symbol] ={2, 4}. In another example, [symbol] ={2, 4, 6, 8}.
In one example,

$${m}^{′} ( x ) = \frac{1}{k} - 1 , 0 or 1 - \frac{1}{k} ,$$

where x∈{0, 1, 2}. Similar to the above examples, k can be fixed or configured via RRC, MAC-CE, or DCI.
In one example,

$${m}^{′} ( x ) = \frac{1}{{k}_{1}} - 1 , \frac{1}{{k}_{2}} - 1 , 1 - \frac{1}{{k}_{2}} , or 1 - \frac{1}{{k}_{1}} ,$$

where x∈{0, 1, 2, 3}.
   In one example, k₁ and k₂ are fixed, e.g., (k₁, k₂)=(4, 2).
   In one example, k₁∈ [symbol] ₁ and k₂∈ [symbol] ₂ and each of k₁ and k₂ can be configured via RRC, MAC-CE or DCI. In one example, [symbol] ₁={6, 8} and [symbol] ₂={2, 4}.
   In one example, k₁ is determined by k₂, e.g., k₁=2k₂. For example, k₂∈ [symbol] ₂ and only k₂ can be configured via RRC, MAC-CE or DCI. In one example, [symbol] ₂={2, 4}, and so on.
In one example,

$${m}^{′} ( x ) = \frac{1}{{k}_{1}} - 1 , \frac{1}{{k}_{2}} - 1 , 0 , 1 - \frac{1}{{k}_{2}} , or 1 - \frac{1}{{k}_{1}} ,$$

where x∈{0, 1, 2, 3, 4}. Similar to the above examples, k₁ and k₂ can be fixed, determined in a pre-rule, or configured via RRC, MAC-CE, or DCI.
In one example, similar to the above examples, we can extend those to the case of N_{BW}^{FH}=5, 6, . . . and so on.
In one example,

$${m}^{′} ( x ) = \frac{n}{k} - 1 or 1 - \frac{n}{k} ,$$

where x∈{0, 1}.
   In one example, k is fixed, e.g., k=2.
   In one example, k∈ [symbol] and can be configured via RRC, MAC-CE, or DCI. In one example, [symbol] ={2, 4}. In another example, [symbol] ={2, 4, 6, 8}.
   In one example, n is fixed, or determined in a rule, or configured via RRC, MAC-CE, or DCI.
In one example,

$${m}^{′} ( x ) = \frac{n}{k} - 1 , 0 or 1 - \frac{n}{k} ,$$

where x∈{0, 1, 2}. Similar to the above examples, k, n can be fixed, determined in a rule, or configured via RRC, MAC-CE, or DCI.
In one example,

$${m}^{′} ( x ) = \frac{{n}_{1}}{{k}_{1}} - 1 , \frac{{n}_{2}}{{k}_{2}} - 1 , 1 - \frac{{n}_{2}}{{k}_{2}} , or 1 - \frac{{n}_{1}}{{k}_{1}} ,$$

where x∈{0, 1, 2, 3}.
   In one example, k₁ and k₂ are fixed, e.g., (k₁, k₂)=(4, 2).
   In one example, k₁∈ [symbol] ₁ and k₂∈ [symbol] ₂ and each of k₁ and k₂ can be configured via RRC, MAC-CE or DCI. In one example, [symbol] ₁={6, 8} and [symbol] ₂={2, 4}.
   In one example, k₁ is determined by k₂, e.g., k₁=2k₂. For example, k₂∈ [symbol] ₂ and only k₂ can be configured via RRC, MAC-CE or DCI. In one example, [symbol] ₂={2, 4}, and so on.
   In one example, n₁ and n₂ are fixed, or determined in a rule or configured viar RRC, MAC-CE, or DCI.
In one example,

$${m}^{′} ( x ) = \frac{{n}_{1}}{{k}_{1}} - 1 , \frac{{n}_{2}}{{k}_{2}} - 1 , 0 , 1 - \frac{{n}_{2}}{{k}_{2}} , or 1 - \frac{{n}_{1}}{{k}_{1}} ,$$

where x∈{0, 1, 2, 3, 4}. Similar to the above examples, k₁, k₂, n₁, and n₂ can be fixed, determined in a pre-rule, or configured via RRC, MAC-CE, or DCI.
In one example, similar to the above examples, we can extend those to the case of N_{BW}^{FH}=5, 6, . . . and so on.

In one example, the outputs of m′(x) are determined according to a table for m′(x). For example, the table includes a configuration parameter, e.g., m_{config}, which indicates N_{BW}^{FH}, and outputs of m′(x). For example, the table can include at least one of the entries in the following table:

TABLE 5
m′ (x) and N^{FH}_{BW} configuration

| m_{config} | N^{FH}_{BW} | m′(0) | m′(1) | m′(2) | m′(3) | . . . |
|---|---|---|---|---|---|---|
| 0 | 2 | −½ | 1/2 | — | — | |
| 1 | 2 | −2/3 | 2/3 | — | — | |
| 2 | 2 | −3/4 | 3/4 | — | — | |
| 3 | 2 | −4/5 | 4/5 | — | — | |
| 4 | 2 | −5/6 | 5/6 | — | — | |
| 5 | 2 | −7/8 | 7/8 | — | — | |
| 6 | 2 | −1/4 | 1/4 | — | — | |
| 7 | 2 | −5/8 | 5/8 | — | — | |
| 8 | 2 | −3/8 | 3/8 | — | — | |
| 9 | 2 | −1/8 | 1/8 | — | — | |
| 10 | 3 | −½ | 0 | 1/2 | — | |
| 11 | 3 | −3/4 | 0 | 3/4 | — | |
| 12 | 3 | −7/8 | 0 | 7/8 | — | |
| 13 | 3 | −1/4 | 0 | 1/4 | — | |
| 14 | 3 | −5/8 | 0 | 5/8 | — | |
| 15 | 3 | −3/8 | 0 | 3/8 | — | |
| 16 | 3 | −1/8 | 0 | 1/8 | — | |
| 17 | 4 | −3/4 | −1/2 | 1/2 | 3/4 | |
| 18 | 4 | −7/8 | −1/2 | 1/2 | 7/8 | |
| 19 | 4 | −7/8 | −3/4 | 3/4 | 7/8 | |
| 20 | 4 | −3/4 | −1/4 | 5/4 | 7/4 | |
| 21 | 4 | −7/8 | −5/8 | 5/8 | 7/8 | |
| 22 | 4 | −7/8 | −3/8 | 3/8 | 7/8 | |
| 23 | 4 | −7/8 | −1/8 | 1/8 | 7/8 | |
| 24 | 4 | −5/8 | −3/8 | 3/8 | 5/8 | |
| 25 | 4 | −5/8 | −1/8 | 1/8 | 5/8 | |
| 26 | 4 | −3/8 | −1/8 | 1/8 | 3/8 | |
| . . . | . . . | . . . | . . . | . . | . . . | |

In one example, the table for m′(x) is a table including any permutation of outputs of m′(x) for any row in Table 5.

In one example, the table for m′(x) is a table including any possible outputs of m′(x) that can be described in example.

In one example, the outputs of m′(x) are determined according to a table for m′(x). For example, the table includes a configuration parameter, e.g., m_{config}, which indicates outputs of m′(x) when N_{BW}^{FH} is given (e.g., by another parameter). For example, the table for a given N_{BW}^{FH} can include at least one of the entries in the following table:

TABLE 6
m′(x) configuration for and N_{BW}^{FH} = 2

| m_{config} | m′(0) | m′(1) |
|---|---|---|
| 0 | −½ | 1/2 |
| 1 | −2/3 | 2/3 |
| 2 | −3/4 | 3/4 |
| 3 | −4/5 | 4/5 |
| 4 | −5/6 | 5/6 |
| 5 | −7/8 | 7/8 |
| 6 | −1/4 | 1/4 |
| 7 | −5/8 | 5/8 |
| 8 | −3/8 | 3/8 |
| 9 | −1/8 | 1/8 |
| . . . | . . . | . . . |

TABLE 7
m′(x) configuration for and N_{BW}^{FH} = 3

| m_{config} | m′(0) | m′(1) | m′(2) |
|---|---|---|---|
| 0 | −½ | 0 | 1/2 |
| 1 | −3/4 | 0 | 3/4 |
| 2 | −7/8 | 0 | 7/8 |
| 3 | −1/4 | 0 | 1/4 |
| 4 | −5/8 | 0 | 5/8 |
| 5 | −3/8 | 0 | 3/8 |
| 6 | −1/8 | 0 | 1/8 |
| . . . | . . . | . . . | . . . |

TABLE 8
m′(x) configuration for and N_{BW}^{FH} = 4

| m_{config} | m′(0) | m′(1) | m′(2) | m′(3) |
|---|---|---|---|---|
| 0 | −3/4 | −1/2 | 1/2 | 3/4 |
| 1 | −7/8 | −1/2 | 1/2 | 7/8 |
| 2 | −7/8 | −3/4 | 3/4 | 7/8 |
| 3 | −3/4 | −1/4 | 1/4 | 3/4 |
| 4 | −7/8 | −5/8 | 5/8 | 7/8 |
| 5 | −7/8 | −3/8 | 3/8 | 7/8 |
| 6 | −7/8 | −1/8 | 1/8 | 7/8 |
| 7 | −5/8 | −3/8 | 3/8 | 5/8 |
| 8 | −5/8 | −1/8 | 1/8 | 5/8 |
| 9 | −3/8 | −1/8 | 1/8 | 3/8 |
| . . . | . . . | . . . | . . . | . . . |

In one example, the table for m′(x) for a given N_{BW}^{FH} is a table including any permutation of outputs of m′(x) for any row in Table 6, 7, or 8.

In one example, the table for m′(x) for a given N_{BW}^{FH} is a table including any possible outputs of m′(x) that can be described herein.

In one example, an offset value a_{offset} can be considered for computing X′. For example, the offset value a_{offset} is added before a modulo operation of N_{BW}^{FH}, which can shift SRS BW length pattern, which is defined by g(x), by a_{offset}. One example can be as follows:

$${X}^{′} = m ( ( {a}_{offset} + {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) .$$

In one example, a_{offset}∈{0, 1, . . . , N_{BW}^{FH}−1} can be configured by RRC, MAC-CE, or DCI.

In one example, a_{offset} can depend on time index, for example, time slot/subframe/frame. In one example, a_{offset}∈{0, 1, . . . , N_{BW}^{FH}−1} is based on a pseudo-random function.

In one example, a pseudo-random function h(·) can be considered for computing X′. For example, the pseudo-random function h(·) is added before a modulo operation of N_{BW}^{FH}, which can pseudo-randomly change the order of SRS BW length pattern that is defined by m′(x). One example can be as follows:

$${X}^{′} = m ( h ( {\sum }_{b = 0}^{{B}_{SRS}} {n}_{b} \cdot {\prod }_{{b}^{′} = b + 1}^{{B}_{SRS}} {N}_{{b}^{′}} ) ) mod {N}_{BW}^{FH} ) .$$

In one example, a pseudo-random function h(·) is a function using the pseudo random sequence c(·) defined by clause 5.2.1 of [6].

In one embodiment, the frequency-domain position offset n_{offset}^{FH} for frequency hopping is given by

$${n}_{offset}^{FH} = Y + {\sum }_{b = 0}^{{B}_{SRS}} {m}_{SRS , b} {N}_{sc}^{RB} {n}_{b}$$

where Y is a quantity that can adjust the frequency-domain position offset n_{offset}^{FH} of SRS sequence across time index.

In one example, Y is a function of n_{b} and N_{b}, f′(n_{b}, N_{b}), for example,

$$Y = l ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$

where l(x) is a function of x∈{0, 1, . . . , N_{BW}^{FH}−1}, and N_{BW}^{FH} is a number of (possible) SRS BWs in an SRS frequency-hopping configuration. In one example, N_{BW}^{FH} is fixed, e.g., N_{BW}^{FH}=2, or can be configured via higher-layer parameter, MAC-CE, or DCI.

In one example, l(x)=(m_{SRS,b}N_{sc}^{RB}/(K_{TC}P_{F}))·g′(x), where g′(x) is a function depending on values of g(x) which is described herein. For example,

$${g}^{′} ( x ) = {\sum }_{i = 0}^{x - 1} ( g ( i ) - 1 ) , for x = 1 , … , {N}_{BW}^{FH} - 1 ,$$

and g′(0)=0.
In one example, g′(0)=0 and g′(1)=−½, when g(0)=½ and g(1)= 3/2 for the case of N_{BW}^{FH}=2.
In one example, g′(0)=0 and g′(1)=½, when g(0)= 3/2 and g(1)=½ for the case of N_{BW}^{FH}=2.
In one example, g′(0)=0, g′(1)=½, and g′(2)=½ when g(0)= 3/2, g(1)=1, and g(2)=½ for the case of N_{BW}^{FH}=3.
In one example, g′(0)=0, g′(1)=−½, and g′(2)=0 when g(0)=½, g(1)= 3/2, and g(2)=1 for the case of N_{BW}^{FH}=3.
In one example, g′(0)=0, g′(1)=−¾, g′(2)=−1, and g′(3)=−¾ when g(0)=¼, g(1)=¾, g(2)= 5/4 and g(3)= 7/4 for the case of N_{BW}^{FH}=4.
When g(i) is available for i=0, . . . N_{BW}^{FH}−2, we can obtain g′(x) using the above equation for x=1, . . . , N_{BW}^{FH}−1.

In one example, l(x)=(m_{SRS,b}N_{sc}^{RB}/(K_{TC}P_{F}))·g′(x), where g′(x) is a function depending on values of m′(x) which is described herein. For example,

$${g}^{′} ( x ) = {\sum }_{i = 0}^{x - 1} {m}^{′} ( i ) , for x = 1 , … , {N}_{BW}^{FH} - 1 ,$$

and g′(0)=0.
In one example, g′(0)=0 and g′(1)=−½, when m′(0)=−½ and m′(1)=½ for the case of N_{BW}^{FH}=2.
In one example, g′(0)=0 and g′(1)=½, when m′(0)=½ and m′(1)=−½ for the case of N_{BW}^{FH}=2.
In one example, g′(0)=0, g′(1)=½, and g′(2)=½ when m′(0)=½, m′(1)=0, and m′(2)=−½ for the case of N_{BW}^{FH}=3.
In one example, g′(0)=0, g′(1)=−½, and g′(2)=0 when m′(0)=−½, m′(1)=½, and m′(2)=0 for the case of N_{BW}^{FH}=3.
In one example, g′(0)=0, g′(1)=−¾, g′(2)=−1, and g′(3)=−¾ when m′(0)=−¾, m′(1)=−¼, m′(2)=¼ and m′(3)=¾ for the case of N_{BW}^{FH}=4.
When m′(i) is available for i=0, . . . N_{BW}^{FH}−2, we can obtain g′(x) using the above equation for x=1, . . . , N_{BW}^{FH}−1.

In one example, l(x)=(m_{SRS,b}N_{sc}^{RB}/(K_{TC}P_{F}))·g′(x), where g′(x) is a function depending on values of g(x) which is described herein. For example,

$${g}^{′} ( x ) = {\sum }_{i = 0}^{x - 1} ( g ( i ) - 1 ) , for x = 1 , … , {N}_{BW}^{FH} - 1 ,$$

and g′(0)=0.
In one example, g′(0)=0 and g′(1)=−½, when g(0)=½ and g(1)= 3/2 for the case of N_{BW}^{FH}=2.
In one example, g′(0)=0 and g′(1)=½, when g(0)= 3/2 and g(1)=½ for the case of N_{BW}^{FH}=2.
In one example, g′(0)=0, g′(1)=½, and g′(2)=½ when g(0)= 3/2, g(1)=1, and g(2)=½ for the case of N_{BW}^{FH}=3.
In one example, g′(0)=0, g′(1)=−½, and g′(2)=0 when g(0)=½, g(1)= 3/2, and g(2)=1 for the case of N_{BW}^{FH}=3.
In one example, g′(0)=0, g′(1)=−¾, g′(2)=−1, and g′(3)=−¾ when g(0)=¼, g(1)=¾, g(2)= 5/4 and g(3)= 7/4 for the case of N_{BW}^{FH}=4.
When g(i) is available for i=0, . . . N_{BW}^{FH}−2, we can obtain g′(x) using the above equation for x=1, . . . , N_{BW}^{FH}−1.

In one example, l(x)=(m_{SRS,b}N_{sc}^{RB}/P_{F})·g′(x), where g′(x) is a function depending on values of m′(x) which is described herein. For example,

$${g}^{′} ( x ) = {\sum }_{i = 0}^{x - 1} {m}^{′} ( i ) , for x = 1 , … , {N}_{BW}^{FH} - 1 ,$$

and g′(0)=0.
In one example, g′(0)=0 and g′(1)=−½, when m′(0)=−½ and m′(1)=½ for the case of N_{BW}^{FH}=2.
In one example, g′(0)=0 and g′(1)=½, when m′(0)=½ and m′(1)=−½ for the case of N_{BW}^{FH}=2.
In one example, g′(0)=0, g′(1)=½, and g′(2)=½ when m′(0)=½, m′(1)=½, and m′(2)=−½ for the case of N_{BW}^{FH}=3.
In one example, g′(0)=0, g′(1)=−½, and g′(2)=0 when m′(0)=−½, m′(1)=½, and m′(2)=0 for the case of N_{BW}^{FH}=3.
In one example, g′(0)=0, g′(1)=−¾, g′(2)=−1, and g′(3)=−¾ when m′(0)=−¾, m′(1)=−¼, m′(2)=¼ and m′(3)=¾ for the case of N_{BW}^{FH}=4.
When m′(i) is available for i=0, . . . N_{BW}^{FH}−2, we can obtain g′(x) using the above equation for x=1, . . . , N_{BW}^{FH}−1.

Embodiments herein under one or multiple constraints can be considered. In one example, P_{F}=1 can only be configured in one embodiment. In another example, either P_{F}=1, or 2 can only be configured in one embodiment.

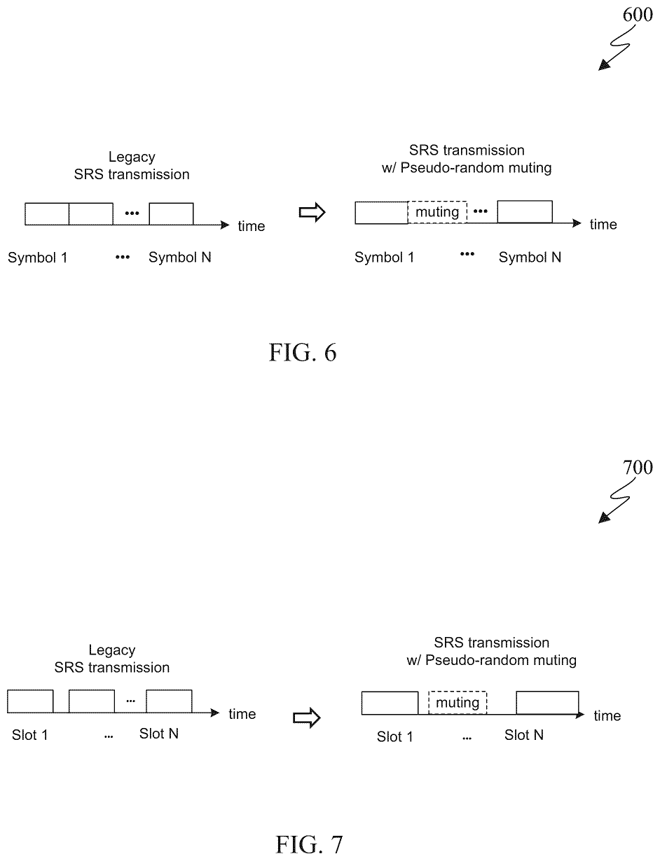

FIG. 6 illustrates an example of SRS transmission with pseudo random muting across time symbols 600 according to embodiments of the present disclosure. The embodiment of the example of SRS transmission with pseudo random muting across time symbols 600 shown in FIG. 6 is for illustration only. FIG. 6 does not limit the scope of this disclosure to any particular implementation of the example of SRS transmission with pseudo random muting across time symbols 600.

FIG. 7 illustrates an example of SRS transmission with pseudo random muting across time slots 700 according to embodiments of the present disclosure. The embodiment of the example of SRS transmission with pseudo random muting across time slots 700 shown in FIG. 7 is for illustration only. FIG. 7 does not limit the scope of this disclosure to any particular implementation of the example of SRS transmission with pseudo random muting across time slots 700.

In one embodiment, a UE is configured to transmit an SRS resource with a pseudo-random muting method, where the pseudo-random muting method includes that the SRS transmission is muting for times which are determined in a pseudo-random manner. The times at which the SRS transmission is muting can be across symbols/slots/subframe/frame. An example illustration of SRS transmission with pseudo random muting across time symbols is shown in FIG. 6. An example illustration of SRS transmission with pseudo random muting across time slots is shown in FIG. 7.

In one embodiment, a parameter t that the SRS transmission is muting depends on a higher-layer parameter, e.g., SRSMutingEnabled in the SRS-Resource IE or the SRS-PosResource IE.

In one example, the parameter t is determined by a function using the pseudo-random sequence c(i) defined by clause 5.2.1 of [6]. For example, t=(t_{muting}+t_{offset})mod X, where:
t_{offset}∈{0, 1, . . . , X−1} is contained in a higher-layer parameter, e.g., SRSMutingEnabled, or t_{offset} is fixed or determined in a rule, or configured via MAC-CE or DCI.
t_{muting} is a function using the pseudo-random sequence c(i), and
X is contained in a higher-layer parameter, e.g., SRSMutingEnabled, or fixed, or determined in a rule, or configured via MAC-CE or DCI.

For example, when t=0, the SRS transmission is muting, i.e., the UE does not transmit the configured SRS at the time when t is computed as 0. In another example, when

$$t = ⌊ \frac{X}{2} ⌋ ,$$

the SRS transmission is muting. In another example, when t∈ [symbol] , the SRS transmission is muting. For example, [symbol] includes 0,

$$⌊ \frac{X}{2} ⌋ .$$

In one example, SRS transmission with pseudo-random muting can be disabled or enabled by the higher-layer parameter SRSMutingEnabled. In one example, it can be one-bit indicator, e.g., 0 and 1 indicating ‘off’, and ‘on’, respectively.

In one example, t_{muting} is a function of time index, using the pseudo-random sequence c(i).
In one example, t_{muting}=fₘᵤₜₑ(n_{s,f}^{μ}), where n_{s,f}^{μ} is a slot number within a frame for subcarrier spacing configuration μ.
   In one example, fₘᵤₜₑ(n_{s,f}^{μ})=c(a·n_{s,f}^{μ}+b). For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, fₘᵤₜₑ(n_{s,f}^{μ})=(Σₘ₌₀^{M-1}c(M(a·n_{s,f}^{μ}+b)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=fₘᵤₜₑ(n_{s,f}^{μ}, l′), where n_{s,f}^{μ} is a slot number within a frame for subcarrier spacing configuration μ, and the quantity l′∈{0, 1, . . . N_{symb}^{SRS}−1} is the OFDM symbol number within the SRS resource.
   In one example, fₘᵤₜₑ(n_{s,f}^{μ}, l′)=c(a·n_{s,f}^{μ}+b+l′). For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, fₘᵤₜₑ(n_{s,f}^{μ})=(Σₘ₌₀^{M-1}c(M(a·n_{s,f}^{μ}+b+l′)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=fₘᵤₜₑ(nₛ^{μ}), where nₛ^{μ} is a slot number within a subframe for subcarrier spacing configuration μ.
   In one example, fₘᵤₜₑ(n_{s,f}^{μ})=c(a·nₛ^{μ}+b). For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, fₘᵤₜₑ(nₛ^{μ})=(Σₘ₌₀^{M-1}c(M(a·nₛ^{μ}+b)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=fₘᵤₜₑ(nₛ^{μ}, l′), where nₛ^{μ} is a slot number within a subframe for subcarrier spacing configuration μ, and the quantity l′∈{0, 1, . . . , N_{symb}^{SRS}−1} is the OFDM symbol number within the SRS resource.
   In one example, fₘᵤₜₑ(nₛ^{μ}, l′)=c(a·nₛ^{μ}+b+l′). For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, fₘᵤₜₑ(nₛ^{μ})=(Σₘ₌₀^{M-1}c(M(a·nₛ^{μ}+b+l′)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .

In one example, t_{muting} is a function of time index and the SRS sequence ID n_{ID}^{SRS}, using the pseudo-random sequence c(i).
In one example, t_{muting}=(fₘᵤₜₑ(n_{s,f}^{μ})+n_{ID}^{SRS}), where n_{s,f}^{μ} is a slot number within a frame for subcarrier spacing configuration μ.
   In one example, fₘᵤₜₑ(n_{s,f}^{μ})=c(a·n_{s,f}^{μ}+b). For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, fₘᵤₜₑ(n_{s,f}^{μ})=(Σₘ₌₀^{M-1}c(M(a·n_{s,f}^{μ}+b)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=(f_{tch}(n_{s,f}^{μ}, l′)+n_{ID}^{SRS})mod X, where n_{s,f}^{μ} is a slot number within a frame for subcarrier spacing configuration μ, and the quantity l′∈{0, 1, . . . N_{symb}^{SRS}−1} is the OFDM symbol number within the SRS resource.
   In one example, fₘᵤₜₑ(n_{s,f}^{μ}, l′)=c(a·n_{s,f}^{μ}+b+l′). For example, a=1. In another example, a=N_{symb}^{slot}, where N_{symb}^{slot} is is a number of symbols per slot. In one example, b=l₀, where l₀ is the starting position described in clause 6.4.1.4.1 of [6].
   In one example, fₘᵤₜₑ(n_{s,f}^{μ})=(Σₘ₌₀^{M-1}c(M(a·n_{s,f}^{μ}+b+l′)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=fₘᵤₜₑ(nₛ^{μ})+n_{ID}^{SRS})mod X, where nₛ^{μ} is a slot number within a subframe for subcarrier spacing configuration μ.
   In one example, fₘᵤₜₑ(nₛ^{μ})=c(a·nₛ^{μ}+b). For example, a=1. In another example, a=N_{symb}^{slot}, where N_{symb}^{slot} is is a number of symbols per slot. In one example, b=l₀, where l₀ is the starting position described in clause 6.4.1.4.1 of [6].
   In one example, fₘᵤₜₑ(nₛ^{μ})=(Σₘ₌₀^{M-1}c(M(a·nₛ^{μ}+b)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, t_{muting}=(fₘᵤₜₑ(nₛ^{μ}, l′)+n_{ID}^{SRS})mod X, where nₛ^{μ} is a slot number within a subframe for subcarrier spacing configuration μ, and the quantity l′∈{0, 1, . . . , N_{symb}^{SRS}−1} is the OFDM symbol number within the SRS resource.
   In one example, fₘᵤₜₑ(nₛ^{μ}, l′)=c(a·nₛ^{μ}+b+l′). For example, a=1. In another example, a=N_{symb}^{slot}, where N_{symb}^{slot} is is a number of symbols per slot. In one example, b=l₀, where l₀ is the starting position described in clause 6.4.1.4.1 of [6].
   In one example, fₘᵤₜₑ(nₛ^{μ})=(Σₘ₌₀^{M-1}c(M(a·nₛ^{μ}+b+l′)+m)·2^{m})mod X. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, a parameter t that the SRS transmission is muting depends on a higher-layer parameter, e.g., SRSMutingInterval in the SRS-Resource IE or the SRS-PosResource IE.

In one example, the parameter t is determined by a function using the pseudo-random sequence c(i) defined by clause 5.2.1 of [6]. For example, t=(t_{muting}+t_{offset})mod X, where:
t_{offset}∈{0, 1, . . . , X−1} is contained in a higher-layer parameter, e.g., SRSMutingEnabled, or t_{offset} is fixed or determined in a rule, or configured via MAC-CE or DCI.
t_{muting} is a function using the pseudo-random sequence c(i), and
X is contained in a higher-layer parameter, e.g., SRSMutingEnabled, or fixed, or determined in a rule, or configured via MAC-CE or DCI.

In one example, the parameter t is defined as t=(t_{muting}+t_{offset})mod X, and t_{muting} is a function of SRS muting interval.
For example, t_{muting}=x·l′ where x is a value configured by SRSMutingInterval, and the quantity l′∈{0, 1, . . . , N_{symb}^{SRS}−1} is the OFDM symbol number within the SRS resource.
   In one example, x∈{0, 1, . . . , X−1}.
   In another example, x∈{1, 2, . . . , X−1}.
For example, t_{muting}=x·l′+n_{ID}^{SRS} where x is a value configured by SRSMutingInterval, the quantity l′∈{0, 1, . . . , N_{symb}^{SRS}−1} is the OFDM symbol number within the SRS resource, and n_{ID}^{SRS} is the SRS sequence ID.
   In one example, x∈{0, 1, . . . , X−1}.
   In another example, x∈{1, 2, . . . , X−1}.

In one example, the value of x (SRSMutingInterval in higher-layer signaling) can be indicated via MAC-CE or DCI.

In one example, an indicator with ┌log₂X┐ bits is used to indicate the value of x∈{0, 1, . . . , X−1} via MAC-CE or DCI.
In one example, an indicator with ┌log₂(X−1)┐ bits is used to indicate the value of x∈{1, 2, . . . , X−1} via MAC-CE or DCI.
In one example, a subset S of {0, 1, . . . , X−1} is configured via higher-layer signaling or MAC-CE, and one of the subset, i.e., x∈S is indicated via an indicator with ┌log₂|S|┐ bits.
In one example, a subset S of {1, 2, . . . , X−1} is configured via higher-layer signaling or MAC-CE, and one of the subset, i.e., x∈S is indicated via an indicator with ┌log₂|S|┐ bits.

In one example, a repetition factor Rₘᵤₜₑ is configured via higher-layer parameter, MAC-CE, or DCI. For example, Rₘᵤₜₑ∈{2, 4}. In another example, Rₘᵤₜₑ∈{2, . . . , N_{symb}^{SRS}}. In another example, Rₘᵤₜₑ∈{2, . . . , N_{symb}^{SRS}−1}. When Rₘᵤₜₑ is configured, t_{muting} can be computed as follows:
In one example,

$${t}_{muting} = x \cdot ⌊ \frac{{l}^{′}}{{R}_{cs}} ⌋ .$$

In one example,

$${t}_{muting} = x \cdot ⌊ \frac{{l}^{′}}{{R}_{cs}} ⌋ + {n}_{ID}^{SRS} .$$

Note that regular muting patterns not relying on a pseudo-random generator could be beneficial when mTRP manages SRS resources in scenarios where interference from mTRP or sTRP associated with other cells is limited. NW with mTRP can manage SRS interference for UEs associated with the NW through regular muting patterns.

In one embodiment, a parameter t that the SRS transmission is muting depends on a higher-layer parameter, e.g., SRSMutingPattern in the SRS-Resource IE or the SRS-PosResource IE. A set of SRS transmission muting patterns can be defined. For example, all of possible combinations (P) with N_{symb}^{SRS} symbols can be considered for a set of SRS transmission muting patterns. In this case, the number of possible combinations can be given by 2^{N}^{_{symb}}^{^{SRS}}. Several examples can be as follows:
In one example, SRS transmission muting patterns for all OFDM symbols are configured via the higher layer parameter SRSMutingPattern
   In one example, SRSMutingPattern includes N_{symb}^{SRS} bits to indicate all of the possible combinations.
In one example, SRS transmission is performed in a first symbol of N_{symb}^{SRS} symbols and SRS transmission muting patterns for the remaining OFDM symbols (i.e., for l′=1, 2, . . . , N_{symb}^{SRS}−1) are configured via higher-layer parameter SRSMutingPattern.
   In one example, SRSMutingPattern includes (N_{symb}^{SRS}−1) bits to indicate all of the possible combinations for l′=1, 2, . . . , N_{symb}^{SRS}−1.

In one embodiment, a subset P_{sub} of all of possible combinations (P) with N_{symb}^{SRS} symbols can be considered for a set of SRS transmission muting patterns.

In one embodiment, a subset P_{sub} of all of possible combinations (P) with N_{symb}^{SRS}− 1 symbols can be considered for a set of SRS transmission muting patterns.

In one embodiment, a parameter t that the SRS transmission is muting is determined by any mixture of the above embodiments.

In one example, the parameter t that the SRS transmission is muting is determined by using pseudo random generator across slots (or subframes/frames) and SRSMutingInterval or SRSMutingPattern across symbols within a slot. For example, for the time slots satisfying t∈ [symbol] , where t=(t_{muting,slot}+t_{offset})mod X, the UE computes SRS transmission muting patterns in symbols by checking t₁∈ [symbol] where t₁=t_{muting,symbol} mod X₁. For example, the UE does not perform SRS transmission when t∈ [symbol] and t₁∈ [symbol] .
t_{offset}∈{0, 1, . . . , X−1} is contained in a higher-layer parameter, e.g., SRSMutingEnabled, or t_{offset} is fixed or determined in a rule, or configured via MAC-CE or DCI.
t_{muting,slot} is a function using the pseudo-random sequence c(i) which outputs SRS transmission muting or not respect to slots,
t_{muting,symbol} is a function of SRS muting interval which outputs SRS transmission muting or not with respect to symbol.
X, X₁ are contained in a higher-layer parameter, e.g., SRSMutingEnabled, or fixed, or determined in a rule, or configured via MAC-CE or DCI.

In one example, t_{muting,slot} can be one of the examples shown herein which do not include l′, and t_{muting,symbol} can be one of the other examples herein.

In one example, t_{muting,slot} can be one of the examples shown herein which do not include l′, and t_{muting,symbol} can be one of other examples herein.

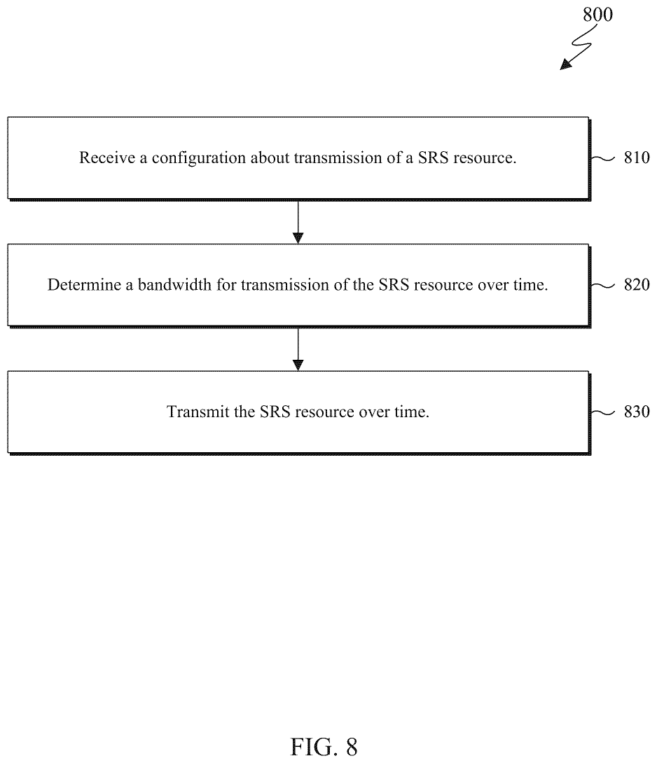

FIG. 8 illustrates an example method 800 performed by a UE in a wireless communication system according to embodiments of the present disclosure. The method 800 of FIG. 8 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method begins with the UE receiving a configuration about transmission of a SRS resource (810). For example, in 810, the configuration includes information about a SRS sequence length of N_{FH}^{BW}>1 and frequency hopping parameters n_{b} and N_{b}, where: N_{FH}^{BW} is a number of an SRS bandwidth and N_{FH}^{BW}>1, n_{b} is a frequency position index, and N_{b} is a value associated with a frequency-hopping pattern.

In various embodiments, the SRS sequence length is based on an expression M_{sc,b}^{SRS}=m_{SRS,b}N_{sc}^{RB}·X/(K_{TC}P_{F}), where m_{SRS,b} is a number of RBs, which is based on a SRS bandwidth configuration, N_{sc}^{RB} is a number of subcarriers in a RB, K_{TC} is a transmission comb number, P_{F} is a scaling factor, and X is a quantity that can vary the SRS sequence length over time and X is a function of: N_{FH}^{BW} and the frequency hopping parameters n_{b} and N_{b}. In various embodiments, X is based on an expression X=f(n_{b}, N_{b})=g((Σ_{b=0}^{B}^{_{SRS}}n_{b}·Π_{b′=b+1}^{B}^{_{SRS}}N_{b′})mod N_{BW}^{FH}), where: B_{SRS} is a parameter based on the SRS bandwidth configuration and g(x) is a function of x, where x∈{0, 1, . . . , N_{BW}^{FH}−1}. In various embodiments, g(x) is based on an expression

$$g ( x ) = \{ \begin{matrix}\frac{1}{2} , for x = 0 \\ \frac{3}{2} , for x = 1\end{matrix} or g ( x ) = \{ \begin{matrix}\frac{3}{2} , for x = 0 \\ \frac{1}{2} , for x = 1\end{matrix} , when {N}_{BW}^{FH} = 2.$$

In various embodiments, the SRS sequence length is based on an expression M_{sc,b}^{SRS}=m_{SRS,b}N_{sc}^{RB}/(K_{TC}P_{F})+X, where: m_{SRS,b} is a number of resource blocks (RBs), which is based on a SRS bandwidth configuration, N_{sc}^{RB} is a number of subcarriers in a RB, K_{TC} is a transmission comb number, P_{F} is a scaling factor, and X′ is a quantity that can vary the SRS sequence length over time, where X′ is a function of N_{FH}^{BW} and the frequency hopping parameters n_{b} and N_{b}. In various embodiments, X′ is based on an expression X′=f(n_{b}, N_{b})=m((Σ_{b=0}^{B}^{_{SRS}}n_{b}·Π_{b′=b+1}^{B}^{_{SRS}}N_{b′})mod N_{BW}^{FH}), where: B_{SRS} is a parameter based on the SRS bandwidth configuration and m(x) is a function of x, where x∈{0, 1, . . . , N_{BW}^{FH}−1}.

In various embodiments, the configuration further includes information related to a frequency-domain position offset, n_{offset}^{FH} and the frequency-domain position offset, n_{offset}^{FH} is based on an expression n_{offset}^{FH}=Y+Σ_{b=0}^{B}^{_{SRS}}m_{SRS,b}N_{sc}^{RB}n_{b}, where: m_{SRS,b} is a number of RBs which is based on an SRS bandwidth configuration, B_{SRS} is a parameter based on the SRS bandwidth configuration, N_{sc}^{RB} is a number of subcarriers in a RB, and where Y is a quantity that can adjust the frequency-domain position offset n_{offset}^{FH} of SRS sequence over time. In various embodiments, Y is based on an expression Y=l((Σ_{b=0}^{B}^{_{SRS}}n_{b}·Π_{b′=b+1}^{B}^{_{SRS}}N_{b′})mod N_{BW}^{FH}), where l(x) is a function of x, where x∈{0, 1, . . . , N_{BW}^{FH}−1}.

The UE then determines a bandwidth for transmission of the SRS resource over time (820). For example, in 820, the determination may be based on the SRS sequence length and the frequency hopping parameters. The UE then transmits the SRS resource over time (830). For example, in 830, the transmission may be based on the determined bandwidth.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about transmission of a sounding reference signal (SRS) resource, the configuration including information about a SRS sequence length of N_{FH}^{BW}>1 and frequency hopping parameters n_{b} and N_{b}, where:
N_{FH}^{BW} is a number of an SRS bandwidth and N_{FH}^{BW}>1,
n_{b} is a frequency position index, and
N_{b} is a value associated with a frequency-hopping pattern; and
a processor operably coupled to the transceiver, the processor configured to determine, based on the SRS sequence length and the frequency hopping parameters, a bandwidth for transmission of the SRS resource over time,
wherein the transceiver is further configured to transmit, based on the determined bandwidth, the SRS resource over time.

2. The UE of claim 1, wherein the SRS sequence length is based on an expression:
M_{sc,b}^{SRS}=m_{SRS,b}N_{sc}^{RB}·X/(K_{TC}P_{F}),
where:
m_{SRS,b} is a number of resource blocks (RBs), which is based on a SRS bandwidth configuration,
N_{sc}^{RB} is a number of subcarriers in a RB,
K_{TC} is a transmission comb number,
P_{F} is a scaling factor, and
X is a quantity that can vary the SRS sequence length over time and X is a function of: N_{FH}^{BW} and the frequency hopping parameters n_{b} and N_{b}.

3. The UE of claim 2, wherein X is based on an expression:
$$X = f ( {n}_{b} , {N}_{b} ) = g ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where:
B_{SRS} is a parameter based on the SRS bandwidth configuration, and
g(x) is a function of x, where x∈{0, 1, . . . , N_{BW}^{FH}−1}.

4. The UE of claim 3, wherein g(x) is based on an expression:
$$g ( x ) = \{ \begin{matrix}\frac{1}{2} , for x = 0 \\ \frac{3}{2} , for x = 1\end{matrix} or g ( x ) = \{ \begin{matrix}\frac{3}{2} , for x = 0 \\ \frac{1}{2} , for x = 1\end{matrix} ,$$
when N_{BW}^{FH}=2.

5. The UE of claim 1, wherein the SRS sequence length is based on an expression:
M_{sc,b}^{SRS}=m_{SRS,b}N_{sc}^{RB}/(K_{TC}P_{F})+X′,
where:
m_{SRS,b} is a number of resource blocks (RBs), which is based on a SRS bandwidth configuration,
N_{sc}^{RB} is a number of subcarriers in a RB,
K_{TC} is a transmission comb number,
P_{F} is a scaling factor, and
X′ is a quantity that can vary the SRS sequence length over time, where X′ is a function of N_{FH}^{BW} and the frequency hopping parameters n_{b} and N_{b}.

6. The UE of claim 5, wherein X′ is based on an expression:
$${X}^{′} = f ( {n}_{b} , {N}_{b} ) = m ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where:
B_{SRS} is a parameter based on the SRS bandwidth configuration, and
m(x) is a function of x, where x∈{0, 1, . . . , N_{BW}^{FH}−1}.

7. The UE of claim 1, wherein:
the configuration further includes information related to a frequency-domain position offset, n_{offset}^{FH}, and
the frequency-domain position offset, n_{offset}^{FH} is based on an expression:
$${n}_{offset}^{FH} = Y + {\sum }_{b = 0}^{{B}_{SRS}} {m}_{SRS , b} {N}_{sc}^{RB} {n}_{b} ,$$
where:
m_{SRS,b} is a number of resource blocks (RBs), which is based on a SRS bandwidth configuration,
B_{SRS} is a parameter based on the SRS bandwidth configuration,
N_{sc}^{RB} is a number of subcarriers in a RB, and
Y is a quantity that can adjust the frequency-domain position offset n_{offset}^{FH} of SRS sequence over time.

8. The UE of claim 7, wherein Y is based on an expression:
$$Y = l ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where l(x) is a function of x, where x∈{0, 1, . . . , N_{BW}^{FH}−1}.

9. A base station (BS) comprising:
a transceiver configured to transmit a configuration about reception of a sounding reference signal (SRS) resource, the configuration including information about a SRS sequence length of N_{FH}^{BW}>1 and frequency hopping parameters n_{b} and N_{b}, where:
N_{FH}^{BW} is a number of an SRS bandwidth and N_{FH}^{BW}>1,
n_{b} is a frequency position index, and
N_{b} is a value associated with a frequency-hopping pattern; and
a processor operably coupled to the transceiver, the processor configured to determine, based on the SRS sequence length and the frequency hopping parameters, a bandwidth for reception of the SRS resource over time,
wherein the transceiver is further configured to receive, based on the determined bandwidth, the SRS resource over time.

10. The BS of claim 9, wherein the SRS sequence length is based on an expression:
M_{sc,b}^{SRS}=m_{SRS,b}N_{sc}^{RB}·X/(K_{TC}P_{F}),
where:
m_{SRS,b} is a number of resource blocks (RBs), which is based on a SRS bandwidth configuration,
N_{sc}^{RB} is a number of subcarriers in a RB,
K_{TC} is a transmission comb number,
P_{F} is a scaling factor, and
X is a quantity that can vary the SRS sequence length over time and X is a function of: N_{FH}^{BW} and the frequency hopping parameters n_{b} and N_{b}.

11. The BS of claim 10, wherein X is based on an expression:
$$X = f ( {n}_{b} , {N}_{b} ) = g ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where:
B_{SRS} is a parameter based on the SRS bandwidth configuration, and
g(x) is a function of x, where x∈{0, 1, . . . , N_{BW}^{FH}−1}.

12. The BS of claim 11, wherein g(x) is based on an expression:
$$g ( x ) = \{ \begin{matrix}\frac{1}{2} , for x = 0 \\ \frac{3}{2} , for x = 1\end{matrix} or g ( x ) = \{ \begin{matrix}\frac{3}{2} , for x = 0 \\ \frac{1}{2} , for x = 1\end{matrix} ,$$
when N_{BW}^{FH}=2.

13. The BS of claim 9, wherein the SRS sequence length is based on an expression:
M_{sc,b}^{SRS}=m_{SRS,b}N_{sc}^{RB}/(K_{TC}P_{F})+X′,
where:
m_{SRS,b} is a number of resource blocks (RBs), which is based on a SRS bandwidth configuration,
N_{sc}^{RB} is a number of subcarriers in a RB,
K_{TC} is a transmission comb number,
P_{F} is a scaling factor, and
X′ is a quantity that can vary the SRS sequence length over time, where X′ is a function of N_{FH}^{BW} and the frequency hopping parameters n_{b} and N_{b}.

14. The BS of claim 13, wherein X′ is based on an expression:
$${X}^{′} = f ( {n}_{b} , {N}_{b} ) = m ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where:
B_{SRS} is a parameter based on the SRS bandwidth configuration, and
m(x) is a function of x, where x∈{0, 1, . . . , N_{BW}^{FH}−1}.

15. The BS of claim 9, wherein:
the configuration further includes information related to a frequency-domain position offset, n_{offset}^{FH}, and
the frequency-domain position offset, n_{offset}^{FH} is based on an expression:
$${n}_{offset}^{FH} = Y + {\sum }_{b = 0}^{{B}_{SRS}} {m}_{SRS , b} {N}_{sc}^{RB} {n}_{b} ,$$
where:
m_{SRS,b} is a number of resource blocks (RBs) which is based on a SRS bandwidth configuration,
B_{SRS} is a parameter based on the SRS bandwidth configuration,
N_{sc}^{RB} is a number of subcarriers in a RB, and
Y is a quantity that can adjust the frequency-domain position offset n_{offset}^{FH} of SRS sequence over time.

16. The BS of claim 15, wherein Y is based on an expression:
$$Y = l ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where l(x) is a function of x, where x∈{0, 1, . . . , N_{BW}^{FH}−1}.

17. A method performed by a user equipment (UE), the method comprising:
receiving a configuration about transmission of a sounding reference signal (SRS) resource, the configuration including information about a SRS sequence length of N_{FH}^{BW}>1 and frequency hopping parameters n_{b} and N_{b}, where:
N_{FH}^{BW} is a number of an SRS bandwidth and N_{FH}^{BW}>1,
n_{b} is a frequency position index, and
N_{b} is a value associated with a frequency-hopping pattern;
determining, based on the SRS sequence length and the frequency hopping parameters, a bandwidth for transmission of the SRS resource over time; and
transmitting, based on the determined bandwidth, the SRS resource over time.

18. The method of claim 17, wherein the SRS sequence length is based on an expression:
M_{sc,b}^{SRS}=m_{SRS,b}N_{sc}^{RB}·X/(K_{TC}P_{F}),
where:
m_{SRS,b} is a number of resource blocks (RBs), which is based on a SRS bandwidth configuration,
N_{sc}^{RB} is a number of subcarriers in a RB,
K_{TC} is a transmission comb number,
P_{F} is a scaling factor, and
X is a quantity that can vary the SRS sequence length over time and X is a function of: N_{FH}^{BW} and the frequency hopping parameters n_{b} and N_{b}.

19. The method of claim 18, wherein X is based on an expression:
$$X = f ( {n}_{b} , {N}_{b} ) = g ( ( {\sum }_{b = 0}^{{B}_{SRS}} {n}_{b} \cdot {\prod }_{{b}^{′} = b + 1}^{{B}_{SRS}} {N}_{{b}^{′}} ) mod {N}_{BW}^{FH} ) ,$$
where:
B_{SRS} is a parameter based on the SRS bandwidth configuration, and
g(x) is a function of x, where x∈{0, 1, . . . , N_{BW}^{FH}−1}.

20. The method of claim 19, wherein g(x) is based on an expression:
$$g ( x ) = \{ \begin{matrix}\frac{1}{2} , for x = 0 \\ \frac{3}{2} , for x = 1\end{matrix} or g ( x ) = \{ \begin{matrix}\frac{3}{2} , for x = 0 \\ \frac{1}{2} , for x = 1\end{matrix} ,$$
when N_{BW}^{FH}=2.
